(19) United States
(12) Patent Application Publication
(10) Pub. No.: US 2007/0001523 A1
(43) Pub. Date: Jan. 4, 2007

(54) Magnetic-positioning motor and fan

(75) Inventors: Hao-Wen Ko, Taoyuan Hsien (TW); Tsung-Yu Lei, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/247,183

(22) Filed: Oct. 12, 2005

(30) Foreign Application Priority Data
Jun. 30, 2005 (JP) 94122145

(51) Int. Cl. H02K 5/24; H02K 7/00; H02K 5/16

(52) U.S. Cl. 310/51; 310/67 R; 417/354; 417/423.12; 310/90

(57) ABSTRACT

The invention provides a magnetic-positioning motor having a magnetic element or magnet disposed at the interior center of a rotor, so that attractive force between the magnetic element and a metallic stator can maintain a rotor at a predetermined position during fan rotation. Additionally, a magnetic element or magnet can be placed on a stator, so that attractive force between the magnetic element and a metallic rotor can maintain a rotor at a predetermined position during fan rotation to reduce vibration, flotation and friction between the shaft and bearing under high speed operation.

### BACKGROUND

The invention relates to a magnetic-positioning motor and fan, and in particular to a magnetic element or magnet placed on a rotor or stator to generate attractive force with respect to a corresponding magnetic coupling element.

Fans serve as heat dissipation devices to exhaust heat in a variety of products. Particularly large-size fans used for dissipating a large amount of heat, however, almost always generate vibration during rotor rotation.

In FIG. 1, a conventional fan C1 comprises a rotor 1 having a shaft 10, a stator 2 having stacked silicon-steel sheets wound by coils, a ball bearing 3 and an sleeve bearing 4 for supporting the shaft 10 respectively.

The rotor 1 has a plurality of blades 11 and a magnetic ring 12. The blades 11 are formed on the outer wall of the rotor 1. The magnetic ring 12 disposed on the inner wall of the rotor is magnetically coupled to the stacked silicon-steel sheets of the stator 2. A magnetic bias is formed by the attractive force and height difference between the magnetic ring 12 and the stacked silicon-steel sheets of the stator 2.

A downward attractive force generated by the magnetic bias can overcome the floating power from the rotor 1 under high speed rotation. As the size and weight of the fan increases, however, the maximum burden of the ball bearing and the sleeve bearing are limited, and attractive force between the magnetic ring and the stacked silicon-steel sheets of the stator is insufficient to depress the floating power from the high-speed rotating rotor.

In FIG. 2, a conventional fan C2 differs from the fan C1 in that the shaft 10 is supported by dual ball bearings 3 and a pre-pressured spring 5 is substantially disposed between the center of the rotor 1 and the ball bearing 3 (upper one in FIG. 2). A recovery force generated by the spring 5 overcomes the floating power from the rotor 1 and reduces vibration during high speed rotation. Although the ball bearings 3 can support a large-size fan, the average cost for each fan of this type is very high, which is a heavy burden for manufacturers.

### SUMMARY

The invention provides a magnetic-positioning fan having a magnetic element or magnet disposed at the interior center of a rotor; thus, attractive force between the magnetic element and a metallic stator can maintain the rotor at a predetermined position during fan rotation. Additionally, a magnetic element or magnet can be placed on a stator; thus, attractive force between the magnetic element and a metal element disposed in a rotor can maintain the rotor at a predetermined position during fan rotation and reduce vibration, flotation and friction between the shaft and bearing under high speed operation. The invention provides a magnetic-positioning fan having one ball bearing and one sleeve bearing, or having only a single sleeve or ball bearing, or even no bearing. Thus, manufacturing costs can be reduced.

The invention provides a magnetic-positioning fan comprising a frame, a stator and a rotor. The stator is located inside the rotor and on the bottom portion of the frame, and is coupled to the rotor. The stator and the rotor are both disposed in the frame. The rotor comprises a shaft centrally disposed on the rotor and longitudinally extending to the center of the stator. Blades are disposed around an outer wall of the rotor and a magnetic ring is disposed on the inner wall of the rotor.

The stator comprises a plurality of coils and stacked silicon-steel sheets wound by the coils. A magnetic element is disposed at the interior center of the rotor and surrounds the shaft. The magnetic element and the stacked silicon-steel sheets of the stator generate attractive force to prevent rotor vibration and flotation under high speed operation.

A magnet or other metallic material can be further disposed on the upper center surface of the stator to surround the shaft and attract the magnetic element. The magnet or metallic materials can be suitable for different fan sizes.

Alternatively, the magnetic element can be placed on the upper center surface of the stator and the magnet or metallic material can be placed on the rotor.

Still, in another embodiment of the invention, a metallic housing can be formed on the inner wall of the rotor and the magnetic element is placed on the upper center surface of the stator and surrounds the shaft, and thus attractive force between the magnetic element and the metallic housing can be generated to position the rotor.

The invention provides a magnetic-positioning fan with a bearing assembly having a ball bearing and an sleeve bearing, a single ball bearing or a single sleeve bearing, or even no bearing or dual ball bearings. Thus, manufacturing costs can be reduced.

### DESCRIPTION OF THE DRAWINGS

The invention can be more fully understood by reading the subsequent detailed description and examples with references made to the accompanying drawings, wherein:

FIG. 1 is a schematic sectional view of a conventional fan.

FIG. 2 is a schematic sectional view of another conventional fan.

FIG. 3 is a schematic sectional view of a magnetic-positioning motor of one embodiment of the invention.

FIG. 4 is an exploded view of the magnetic-positioning motor of FIG. 3.

FIG. 5A is a schematic sectional view of a magnetic-positioning fan of one embodiment of the invention.

FIG. 5B is an enlarged view of the dotted area in FIG. 5A.

FIG. 6 is an exploded view of the magnetic-positioning fan of FIG. 5A.

FIG. 7A is a schematic view of a magnetic element positioned by a plurality of hooks extending from a rotor.

FIG. 7B is an exploded view of the assembled structure of FIG. 7A.

FIG. 8A is a schematic view of a magnetic element positioned by a groove formed on the outer wall of a supporting portion of a rotor.

FIG. 8B is a schematic view of the supporting portion of the rotor of FIG. 8A.

FIG. 8C is a top view of the magnetic element of FIG. 8A

FIG. 9A is a schematic view of a magnetic element positioned on a supporting portion of a rotor by interference fit.

FIG. 9B is an exploded view of the assembled structure of FIG. 9A.

FIG. 10A is a schematic view of a magnetic element positioned by a protrusion of a supporting portion of a rotor.

FIG. 10B is an exploded view of the assembled structure of FIG. 10A.

FIG. 11A is a schematic view of a magnetic element positioned on a supporting portion of a rotor by adhesive.

FIG. 11B is an exploded view of the assembled structure of FIG. 11A.

FIG. 12 is a schematic view of a magnetic-positioning fan of another embodiment of the invention.

FIG. 13 is a schematic view of a magnetic-positioning fan of another embodiment of the invention.

FIG. 14 is a schematic view of a magnetic-positioning fan of another embodiment of the invention.

FIG. 15 is a schematic view of a magnetic-positioning fan of another embodiment of the invention.

FIG. 16 is a schematic view of a magnetic-positioning fan of another embodiment of the invention.

FIG. 17 is a schematic view of a magnetic-positioning fan of another embodiment of the invention.

FIG. 18 is a schematic view of a magnetic-positioning fan of another embodiment of the invention.

FIG. 19 is a schematic view of a magnetic-positioning fan of another embodiment of the invention.

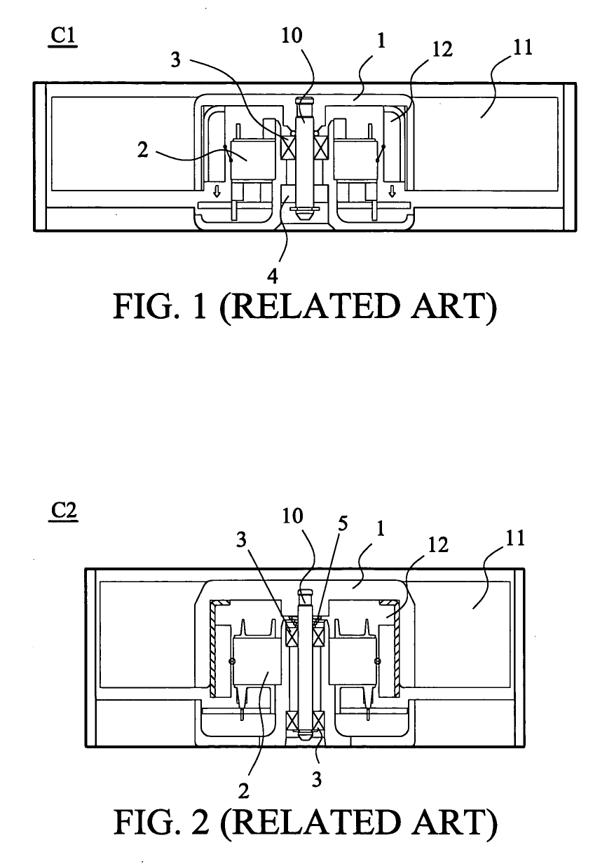

### DETAILED DESCRIPTION

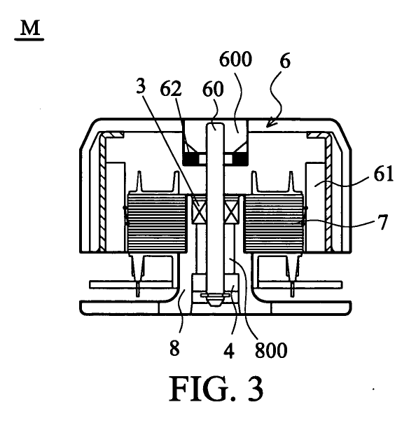

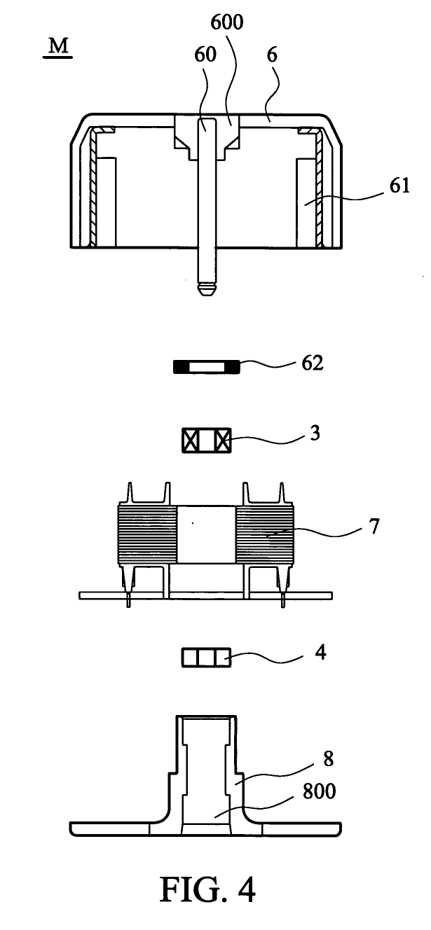

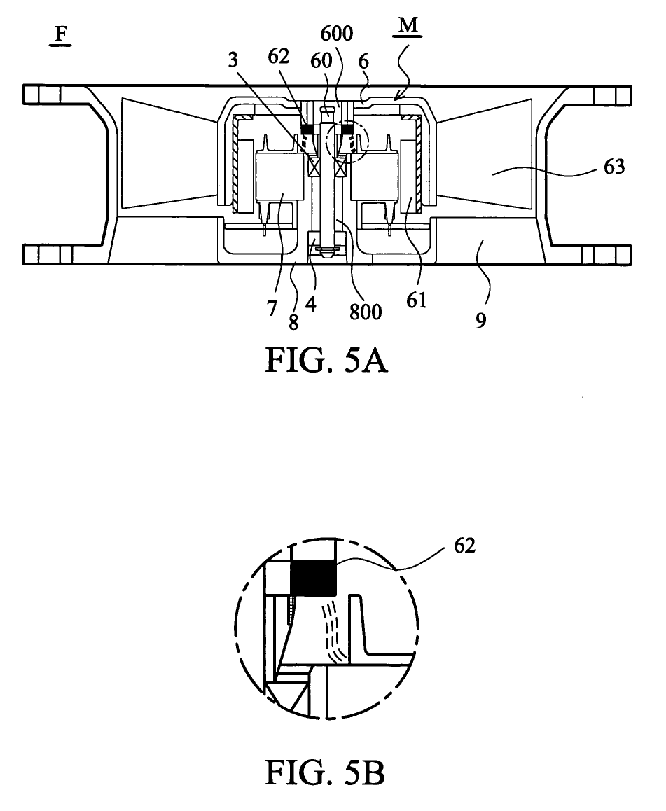

In FIGS. 3 and 4, a magnetic-positioning motor M for a magnetic-positioning fan F (shown in FIG. 5A) comprises a bearing assembly having a ball bearing 3 and a sleeve bearing 4, a rotor 6 having a supporting portion 600, a shaft 60, a magnetic ring 61 disposed on the inner wall of the rotor 6, a magnetic element 62 disposed on the supporting portion 600, a stator 7 and a base 8.

The base 8 has a receiving portion 800 for receiving the shaft 60 of the rotor 6. The ball bearing 3 and the sleeve bearing 4 are disposed in the receiving portion 800 to support the shaft 60. The ball bearing 3 disposed in the receiving portion 800 is closer to the magnetic element 62 than the sleeve bearing 4.

The stator 7, located inside the rotor 6, is coupled to the rotor 6 and jacketed on the exterior of the base 8. The stator 7 comprises a plurality of coils and stacked silicon-steel sheets wound by the coils. The magnetic ring 61 of the rotor 6 and the stator 7 form magnetic force to rotate the rotor 6 after being powered. It is noted that the ball bearing 3 has to be disposed below an upper surface of the stator 7 to avoid the magnetic interference generated by the ball bearing 3 and the magnetic elements. Thus, the magnetic element 62 and the stacked silicon-steel sheets of the stator 7 generate attractive force to prevent vibration and flotation of the rotor 6 under high speed operation.

The supporting portion 600 extends from the interior center of the rotor 6 to enclose the shaft 60. The shaft 60, supported by the ball bearing 3 and the sleeve bearing 4, is centrally disposed in the supporting portion 600 of the rotor 6 and extends longitudinally to the center of the stator 7. The magnetic element 62 is a positioning magnet circumferentially disposed on the outer wall of the supporting portion 600 and surrounds the shaft 60.

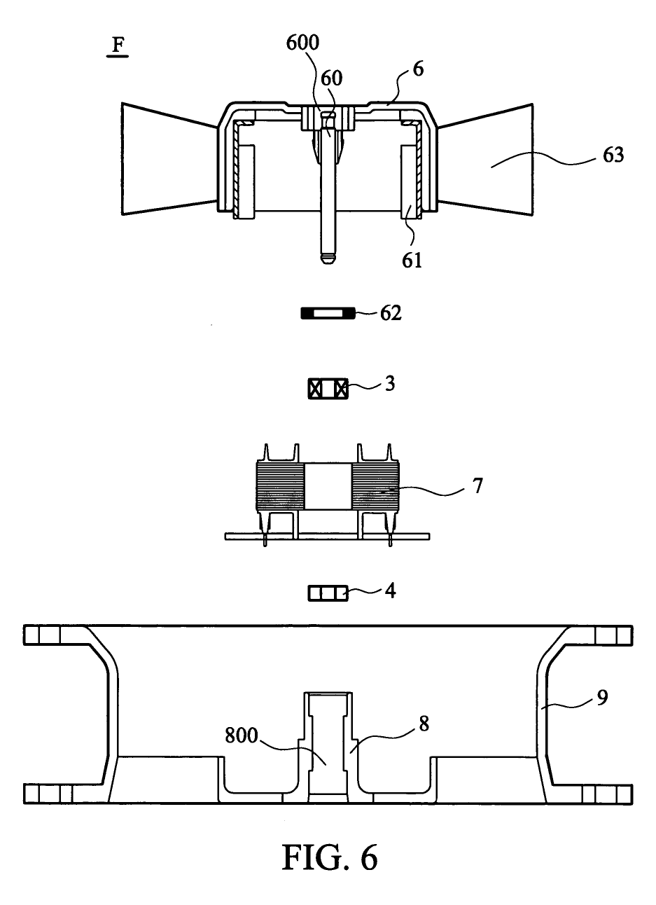

In FIGS. 5A, 5B and 6, the magnetic-positioning fan F comprises the described magnetic-positioning motor M, a plurality of blades 63 and a frame 9. The rotor 6 and the stator 7 are disposed in the frame 9 and the base 8 is disposed on the bottom of the frame 9. The blades 63 are disposed around an outer wall of the rotor 6. The shaft 60 is supported by the ball bearing 3 and the sleeve bearing 4. The ball bearing 3, the sleeve bearing 4, the rotor 6, the magnetic element 62 and the stator 7 have the same position and disposition as the described magnetic-positioning motor M in FIGS. 3 and 4.

Note that the ball bearing 3 is lower than the upper surface of the stacked silicon-steel sheets to stabilize attraction between the magnetic element 62 and the stacked silicon-steel sheets of the stator 7 and prevent the attractive force between the magnetic element 62 and the stator 7 from being affected by the ball bearing 3.

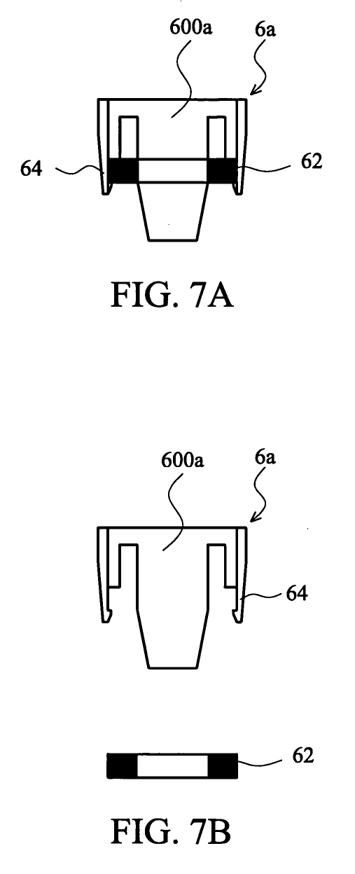

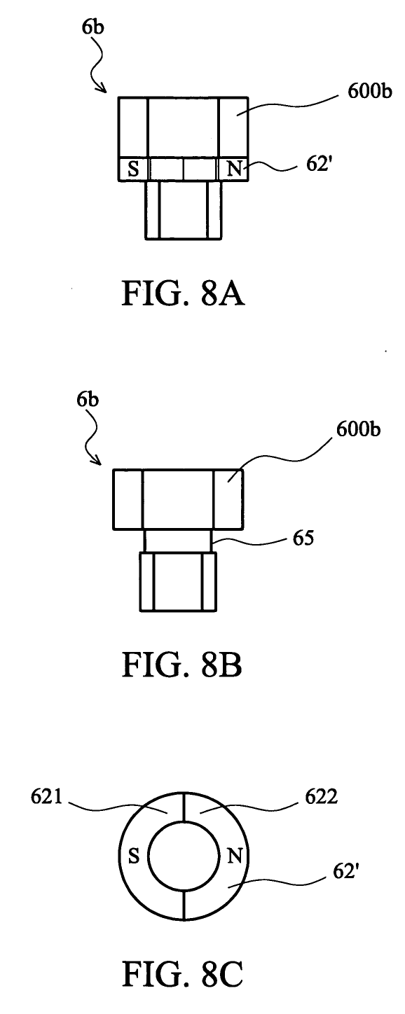

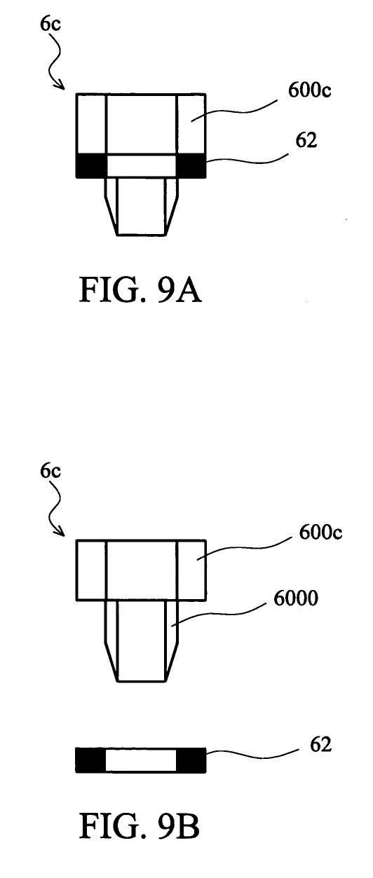

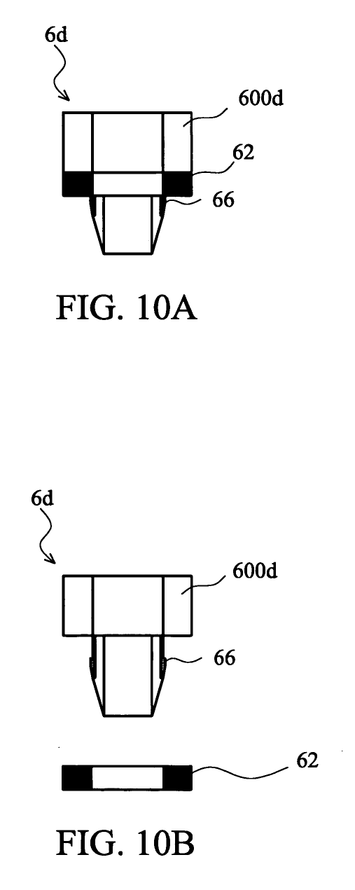

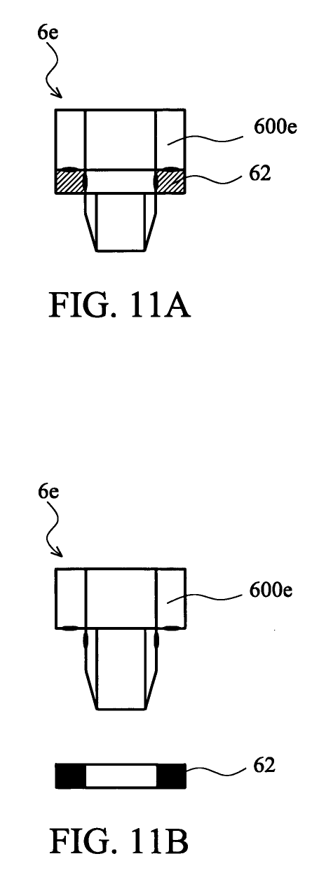

Additionally, the magnetic element 62 can be fixed on the rotor 6 by different methods. For example, in FIGS. 7A and 7B, the magnetic-positioning motor comprises a supporting portion 600a extending from the interior center of the rotor 6 to enclose the shaft 60 and a plurality of hooks 64 longitudinally extending from the interior center of the rotor 6 to engage the magnetic element 62. Thus, the magnetic element 62 is stably positioned. In FIGS. 8A to 8C, the magnetic-positioning motor comprises a supporting portion 600b extending from the interior center of the rotor 6b to enclose the shaft 60 and having a groove 65 formed on the outer wall of the supporting portion 600b. The magnetic element 62′ comprises two magnets 621 and 622 having opposing magnetic poles S and N respectively. The width of the groove 65 is similar to the thickness of the magnetic element 62′, and the outer diameter of the groove 65 of the rotor 6b is similar to the aperture diameter of the magnetic element 62′. Thus, the magnets 621 and 622 can be connected when positioned in the groove 65 of the supporting portion 600b. In 9A to 9B, the partial outer diameter of the upper portion 6000 of the supporting portion 600c is substantially greater than the aperture diameter of the magnetic element 62, thus, the magnetic element 62 and the supporting portion 600c are engaged together by interference fit. In FIGS. 10A and 10B, the supporting portion 600d of the rotor 6d comprises at least one protrusion 66 to support the magnetic element 62. In this embodiment, the protrusion 66 is a fin-shaped member to hook the magnetic element 62. In FIGS. 11A and 11B, the outer wall of the supporting portion 600e of the rotor 6e is connected to the magnetic element 62 by adhesive.

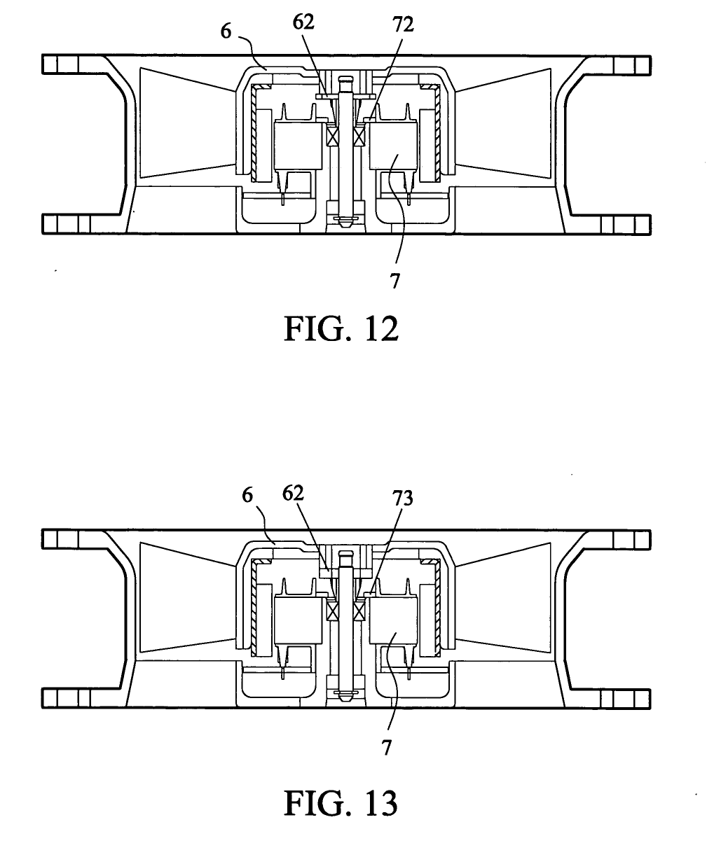

In FIG. 12, the magnetic-positioning fan further comprises a magnetic coupling element 72 disposed on an upper surface of the stator 7 and facing the magnetic element 62. The magnetic coupling element 72 has a magnetic pole opposite to the magnetic element 62. In FIG. 13, the magnetic-positioning fan further comprises a metallic sheet 73 disposed on an upper surface of the stator 7 and facing the magnetic element 62. In this embodiment, the metallic sheet 73 is an iron plate coupled to the magnetic element 62.

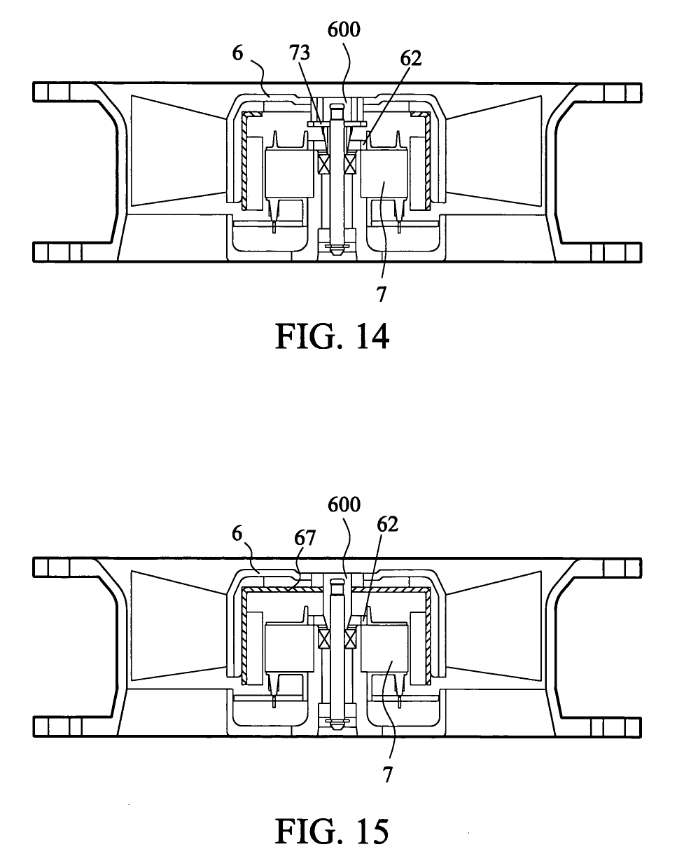

FIGS. 14 and 15 show two embodiments of the invention respectively. In FIG. 14, the magnetic element 62 is centrally disposed on the stacked silicon-steel sheets of the stator 7, and the magnetic coupling element 72 having an opposite magnetic pole with respect to the magnetic element 62 or metallic sheet 73 is disposed on the supporting portion 600 of the rotor 6. In FIG. 15, a metallic housing 67 formed on the inner wall of the rotor 6 extends to the interior center of the rotor 6. The magnetic element 62 is centrally disposed on the stacked silicon-steel sheets of the stator 7, but no further object is added to the supporting portion 600 of the rotor 6. The metallic housing 67 is a magnetic coupling element to generate attractive force with the magnetic element 62 to maintain the rotor 6 at a predetermined position during fan rotation.

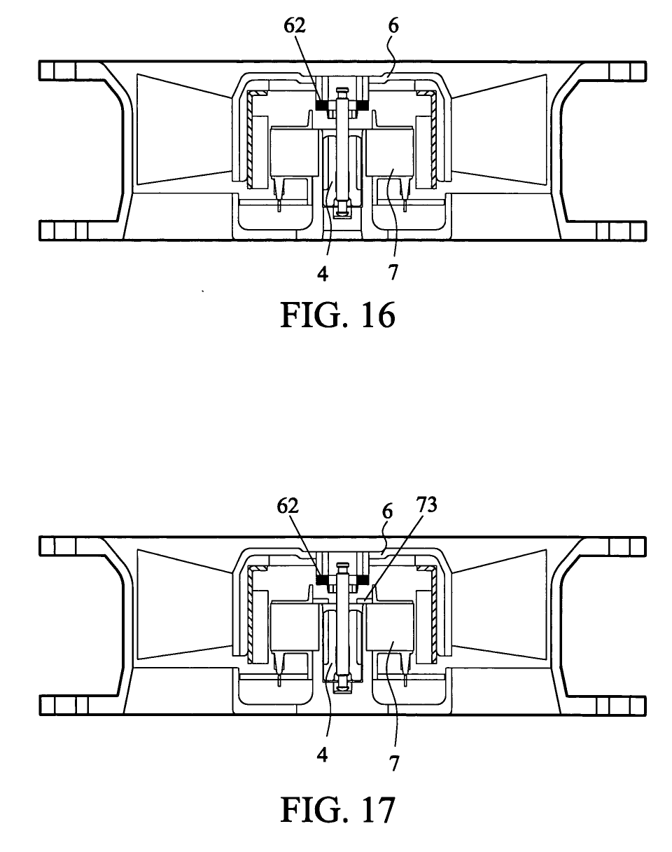

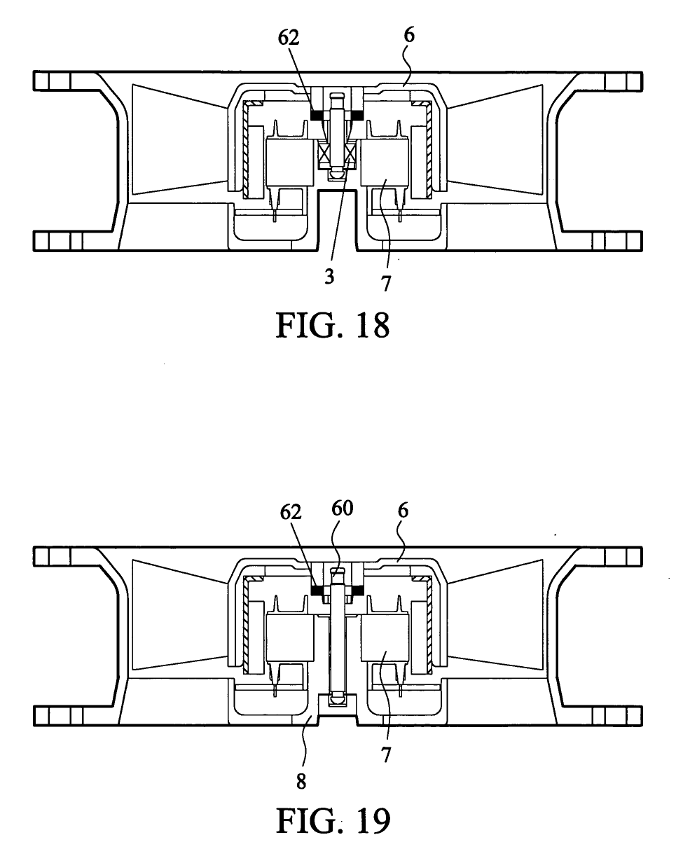

Note that the described embodiments are not limited to the use of both the ball bearing 3 and the sleeve bearing 4. If the magnetic element 62 and the stacked silicon-steel sheets of the stator 7 can generate sufficient attractive force to maintain the rotor 6 at the predetermined position during fan rotation, a single sleeve bearing 4 (in FIGS. 16 and 17) or a single ball bearing 3 (in FIG. 18) is adequate to support the shaft 60. In FIG. 19, no bearing is also possible if the two kinds of attractive force between the magnetic ring 61 of the rotor 6 and the stacked silicon-steel sheets of the stator 7 and between the magnetic element 62 and the stacked silicon-steel sheets are substantial enough to maintain the rotor 6 at the predetermined position during fan rotation. Thus, the shaft 60 can stably rotate by abutting the base 8.

The invention provides a large-size, magnetic-positioning fan without dual ball bearings so as to preventing vibration and flotation of the rotor 6 under high speed operation. Thus, manufacturing costs can be reduced.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A magnetic-positioning motor, comprising:
a base;
a stator jacketed on the base;
a rotor comprising a shaft extending to the center of the stator;
a magnetic ring disposed in the rotor and enclosing the stator; and
a magnetic element disposed inside the rotor and surrounding the shaft.

2. The magnetic-positioning motor as claimed in claim 1, wherein the base comprises a receiving portion for receiving the shaft of the rotor, and the magnetic-positioning motor further comprises a bearing assembly disposed in the receiving portion to support the shaft.

3. The magnetic-positioning motor as claimed in claim 2, wherein the bearing assembly comprises a ball bearing and a sleeve bearing, and the ball bearing is closer to the magnetic element than the sleeve bearing.

4. The magnetic-positioning motor as claimed in claim 3, wherein a top surface of the ball bearing is farther from the magnetic element than a top surface of the stator.

5. The magnetic-positioning motor as claimed in claim 2, wherein the bearing assembly comprises a sleeve bearing or a ball bearing.

6. The magnetic-positioning motor as claimed in claim 1 further comprising a plurality of hooks extending from the interior of the rotor to engage the magnetic element.

7. The magnetic-positioning motor as claimed in claim 1 further comprising a supporting portion extending from the interior of the rotor to enclose the shaft, wherein the magnetic element is circumferentially disposed on the outer wall of the supporting portion.

8. The magnetic-positioning motor as claimed in claim 7, wherein the magnetic element comprises two magnets having two opposite magnetic poles respectively, and a groove formed on the outer wall of the supporting portion for connection of the two magnets.

9. The magnetic-positioning motor as claimed in claim 7, wherein the supporting portion comprises at least one protrusion to support the magnetic element.

10. The magnetic-positioning motor as claimed in claim 9, wherein the protrusion is a fin-shaped member.

11. The magnetic-positioning motor as claimed in claim 7, wherein the outer wall of the supporting portion is connected to the magnetic element by adhesive.

12. The magnetic-positioning motor as claimed in claim 7, wherein a partial outer diameter of the supporting portion is substantially greater than the aperture diameter of the magnetic element so as to enable the magnetic element to engage the supporting portion by interference fit.

13. The magnetic-positioning motor as claimed in claim 1 further comprising a magnetic coupling element disposed on one side of the stator and facing the magnetic element, wherein the magnetic coupling element has a magnetic pole opposite to the magnetic element.

14. The magnetic-positioning motor as claimed in claim 1 further comprising a metallic sheet disposed on one side of the stator and facing the magnetic element, wherein the metallic sheet is coupled to the magnetic element.

15. A magnetic-positioning motor, comprising:
a base;
a stator jacketed on the base;
a rotor comprising a shaft extending to the center of the stator;
a magnetic ring disposed in the rotor and enclosing the stator;
a magnetic element disposed on the stator and surrounding the shaft; and
a magnetic coupling element disposed inside the rotor and interacting with the magnetic element to generate a magnetic force.

16. The magnetic-positioning motor as claimed in claim 15, further comprising a bearing assembly disposed in the base for supporting the shaft.

17. The magnetic-positioning motor as claimed in claim 15, wherein the magnetic coupling element comprises a metallic housing formed on the inner wall of the rotor.

18. The magnetic-positioning motor as claimed in claim 15, wherein the magnetic coupling element comprises a metallic sheet disposed inside the rotor and surrounding the shaft.

19. A magnetic-positioning fan, comprising:
a frame comprising a base;
a stator jacketed on the base;
a rotor disposed in the frame, comprising a shaft extending to the center of the stator;
a magnetic ring disposed in the rotor and enclosing the stator;
a plurality of blades disposed around an outer wall of the rotor; and
a magnetic element disposed on the stator and surrounding the shaft.

20. A magnetic-positioning fan, comprising:
a frame comprising a base;
a stator jacketed on the base;
a rotor disposed in the frame, comprising a shaft extended to the center of the stator;
a magnetic ring disposed in the rotor and enclosing the stator;
a plurality of blades disposed around an outer wall of the rotor;
a magnetic element disposed on the stator and surrounding the shaft; and
a magnetic coupling element disposed inside the rotor and interacting with the magnetic element to generate magnetic force.
